(19) United States
(12) Patent Application Publication
(10) Pub. No.: US 2025/0322324 A1
(43) Pub. Date: Oct. 16, 2025

(54) Integrated Management & Governance of Document Portfolio

(71) Applicant: Bernt Erik Bjontegard, San Diego, CA (US)

(72) Inventor: Bernt Erik Bjontegard, San Diego, CA (US)

(21) Appl. No.: 18/987,278

(22) Filed: Dec. 19, 2024

Related U.S. Application Data
(60) Provisional application No. 63/612,375, filed on Dec. 20, 2023.

(51) Int. Cl. G06Q 10/063; G06F 16/93; G06Q 30/0202

(52) U.S. Cl. CPC G06Q 10/063; G06F 16/93; G06Q 30/0202

(57) ABSTRACT

An integrated document portfolio management and governance system and method are disclosed. The system includes a computing unit having an application interface adapted to present and/or formulate at least one input query. The system further includes aa central controller having a backend server communicably connected to the application interface of the computing unit. The backend server includes a data receiving component adapted to receive document dataset, each comprising a plurality of data elements, from a plurality of data sources in one or more formats. The backend server further includes a data ingestion module adapted to detect, normalize, and aggregate the plurality of data elements of the document dataset and subsequently store them within a central data repository. Furthermore, the backend server includes an ontology generator module adapted to create and maintain a dynamic ontology for the ingested datasets in real-time, wherein the plurality of data elements is categorized and contextualized in accordance with the dynamic ontology. Additionally, the backend server includes a governance module adapted to enforce & monitor data compliance policies and a data analysis module adapted to analyze the ingested data and generate actionable insights, wherein the actionable insights include one or more predictive analysis, data accuracy status, governance status, operational inefficiency, risk indicators, compliance gaps, and risk lineage and integrity. In operation, a user formulates an input query towards the central controller which in response is configured to automatically manage, govern & monitor the received data and subsequently visualize one or more actionable insights and/or compliance gaps onto the application interface of the computing unit.

### FIELD OF THE INVENTION

The present invention relates to the field of data management and governance, more specifically to a system for integrated management and governance of a document portfolio.

### BACKGROUND

In today's data-driven world, organizations face significant challenges in managing and extracting actionable insights from vast volumes of documents. This problem is particularly prevalent in industries such as finance, healthcare, law, and government, where massive quantities of documents, often in diverse formats and from disparate sources, need to be processed, analyzed, and stored. The sheer scale of data involved, coupled with varying standards, regulatory requirements, and the complexity of extracting relevant insights, makes it increasingly difficult to manage these portfolios effectively.

One of the primary obstacles in handling large document portfolios is the fragmentation of data across multiple silos or repositories. These silos often result from organizational divisions, technological limitations, or differing standards and formats of data. When data is spread across separate systems, the ability to gain a detailed view of the information is hindered, making it more difficult to extract useful insights. Traditional methods of document management, which rely on keyword searches and manual categorization, fail to efficiently deal with the size, complexity, and scale of modern document portfolios. As a result, organizations struggle with inefficiencies, errors, and delays in obtaining key insights, leading to increased operational costs and missed opportunities.

Another critical challenge is ensuring that documents comply with a wide array of regulatory standards and legal requirements. Industries such as healthcare and finance are subject to stringent regulations that govern how sensitive data is stored, accessed, and shared. Inconsistent governance and a lack of standardization often lead to violations of compliance standards, which can result in fines, reputational damage, or legal consequences. Furthermore, the absence of standardized frameworks for managing data across different sources and formats makes it even more difficult for organizations to ensure that their data governance processes are consistent, secure, and in line with regulatory expectations.

Furthermore, the challenge of extracting actionable insights from unstructured data is ever-present. Many of the documents that need to be analyzed are not easily searchable or sortable, particularly when they contain large amounts of unstructured text or data. Without an efficient means of identifying key data points or relevant information within these documents, organizations struggle to make informed decisions based on the data at their disposal. In many cases, valuable insights remain buried within these documents, inaccessible due to the lack of a structured approach to organizing and categorizing the information.

Fraud detection and risk management are also significant concerns, particularly in document-intensive sectors like finance and healthcare. Manual oversight and traditional data management approaches are often not equipped to identify fraudulent activities or anomalies at scale. Without automated, efficient systems in place to detect inconsistencies or unusual patterns in large document portfolios, organizations are left exposed to greater risks of fraud and non-compliance.

Moreover, as data continues to grow at an exponential rate, the task of managing and deriving insights from vast document portfolios becomes even more daunting. With the increasing volume of documents being produced by businesses, governments, and other organizations, the need for scalable, automated solutions has never been more pressing. Traditional methods of data governance, document analysis, and compliance management simply cannot keep pace with the demands of modern data environments. As a result, businesses are often left to rely on outdated systems or manual processes that fail to meet the evolving needs of their organizations.

### SUMMARY

The present invention relates to the field of data management and governance, more specifically to a system for management and governance of a document portfolio by generating actionable insights based on the ingested data.

In one aspect of the present invention, a system for integrated management and governance of a document portfolio is disclosed that operates as a comprehensive framework for handling and governing vast datasets across various formats and sources. It includes a computing unit that includes an application interface, enabling users to present or formulate queries to retrieve, analyze, or manage document data efficiently. These queries, initiated through the interface, are directed to a central controller for execution, ensuring a smooth flow of communication and precise results. The backend server of the central controller forms the core of the system, incorporating advanced components like the data receiving module, which is responsible for ingesting datasets comprising structured, semi-structured, and unstructured data. Once the data is received, the data ingestion module processes it by detecting, normalizing, and aggregating the elements into a central repository. This ensures that all incoming data, regardless of format or structure, is harmonized and made accessible for further analysis. To provide contextual understanding and categorization, the ontology generator module dynamically creates and maintains an ontology tailored to the ingested datasets. The ontology generator also collaborates with human experts to refine the data structure and dynamically updates it to adapt to changes in data sources or content. The governance module enforces and monitors compliance policies, such as data access control and adherence to regulatory standards like GDPR or HIPAA. This ensures robust data governance and enables organizations to maintain transparency and accountability in data handling. To address compliance gaps identified during analysis, the compliance module can initiate automated corrective actions, further enhancing operational efficiency. Additionally, the system's data analysis module applies advanced analytics to generate actionable insights, such as predictive trends, data accuracy metrics, risk indicators, and compliance statuses.

In another aspect of the present invention, a document portfolio management and governance method are disclosed. The method involves presenting and formulating input queries via an application interface, establishing a communicable connection with a backend server, and receiving document datasets from diverse sources in multiple formats, including structured, semi-structured, and unstructured data. These datasets undergo detection, normalization, and aggregation, followed by storage in a centralized repository. A dynamic ontology categorizes and contextualizes data in real-time, enabling seamless organization and analysis. Data compliance policies, such as access control, are enforced and monitored to ensure regulatory adherence. Advanced analytics generate actionable insights, including predictive trends, data accuracy evaluations, operational inefficiencies, risk indicators, and compliance gaps. The method further enables automated management and governance of data, with visualized insights and compliance metrics displayed on the application interface, ensuring streamlined operations and informed decision-making.

In an aspect, the received dataset comprises structured, semi-structured, and unstructured data.

In yet another aspect, the backend server is communicably connected to the application interface via., a communication medium that includes 5G, private 5G, 6G, Wi-Fi, BLT and beacons, WiFi-6, LPWA, Peer to Peer, Audio, Voice, Alexa, Siri, Google Voice, POS, and Scanners.

Advantageously, the ontology generator module collaborates with human experts to refine the ontology associated with the ingested datasets.

### BRIEF DESCRIPTION OF THE ACCOMPANYING DRAWINGS

The above-mentioned implementations are further described herein regarding the accompanying figures. It should be noted that the description and figures relate to exemplary implementations and should not be construed as a limitation to the present disclosure. It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

FIG. 1 depicts an exemplary document portfolio management and governance system.

FIG. 2 depicts details of the received dataset used for the generation of the insights.

FIG. 3 depicts details of the plurality of sources from where the dataset is received.

FIG. 4 depicts a communication medium used to establish a communicable connection between the backend server and the application interface.

FIG. 5 depicts various sub-modules of the ontology generator module.

FIG. 6 depicts various sub-modules of the governance module.

FIG. 7 depicts various sub-modules of the data analytics module.

FIG. 8 depicts details of the dataset enabled by the metadata.

FIG. 9 depicts details of the compliance policies to define and enforce rules for data governance based on regulatory and industry standards.

FIG. 10 depicts details of the governance policies adapted to enforce & monitor data compliance policies.

FIG. 11 depicts an exemplary document portfolio management and governance process.

### DETAILED DESCRIPTION

Embodiments, of the present disclosure, will now be described with reference to the accompanying drawing.

In the following description, certain specific details are outlined to provide a thorough understanding of various disclosed embodiments. However, one skilled in the relevant art will recognize that embodiments may be practiced without one or more of these specific details, or with other methods, components, materials, etc.

Unless the context indicates otherwise, throughout the specification and claims which follow, the word “comprises” and variations thereof, such as, “comprises” and “comprising” are to be construed in an open, inclusive sense that is as “including, but not limited to.” Further, the terms “first,” “second,” and similar indicators of the sequence are to be construed as interchangeable unless the context clearly dictates otherwise.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content dictates otherwise. It should also be noted that the term “or” is generally employed in its broadest sense, that is, as meaning “and/or” unless the content dictates otherwise.

A system for integrated management and governance of a document portfolio is disclosed that operates as a comprehensive framework for handling and governing vast datasets across various formats and sources. It includes a computing unit that includes an application interface, enabling users to present or formulate queries to retrieve, analyze, or manage document data efficiently. These queries, initiated through the interface, are directed to a central controller for execution, ensuring a smooth flow of communication and precise results. The backend server of the central controller forms the core of the system, incorporating advanced components like the data receiving module, which is responsible for ingesting datasets comprising structured, semi-structured, and unstructured data.

Once the data is received, the data ingestion module processes it by detecting, normalizing, and aggregating the elements into a central repository. This ensures that all incoming data, regardless of format or structure, is harmonized and made accessible for further analysis. To provide contextual understanding and categorization, the ontology generator module dynamically creates and maintains an ontology tailored to the ingested datasets. The ontology generator also collaborates with human experts to refine the data structure and dynamically updates it to adapt to changes in data sources or content.

The governance module enforces and monitors compliance policies, such as data access control and adherence to regulatory standards like GDPR or HIPAA. This ensures robust data governance and enables organizations to maintain transparency and accountability in data handling. To address compliance gaps identified during analysis, the compliance module can initiate automated corrective actions, further enhancing operational efficiency. Additionally, the system's data analysis module applies advanced analytics to generate actionable insights, such as predictive trends, data accuracy metrics, risk indicators, and compliance statuses.

The document portfolio management and governance system offer significant advantages by providing a comprehensive and integrated approach to managing and governing document portfolios, addressing key challenges like data diversity, compliance, and actionable insight generation. Its ability to handle structured, semi-structured, and unstructured data from multiple sources ensures adaptability to complex organizational environments, while the dynamic ontology generator enhances data contextualization and retrieval. The governance module enforces robust compliance with industry regulations, mitigating risks and ensuring auditability, while the data analysis module delivers predictive insights, fraud detection, and operational efficiency improvements. By automating data ingestion, compliance monitoring, and real-time visualization, the system reduces manual effort, increases accuracy, and enables proactive decision-making. This unified platform supports scalability, transparency, and advanced analytics, making it indispensable for industries requiring stringent data governance and insightful management.

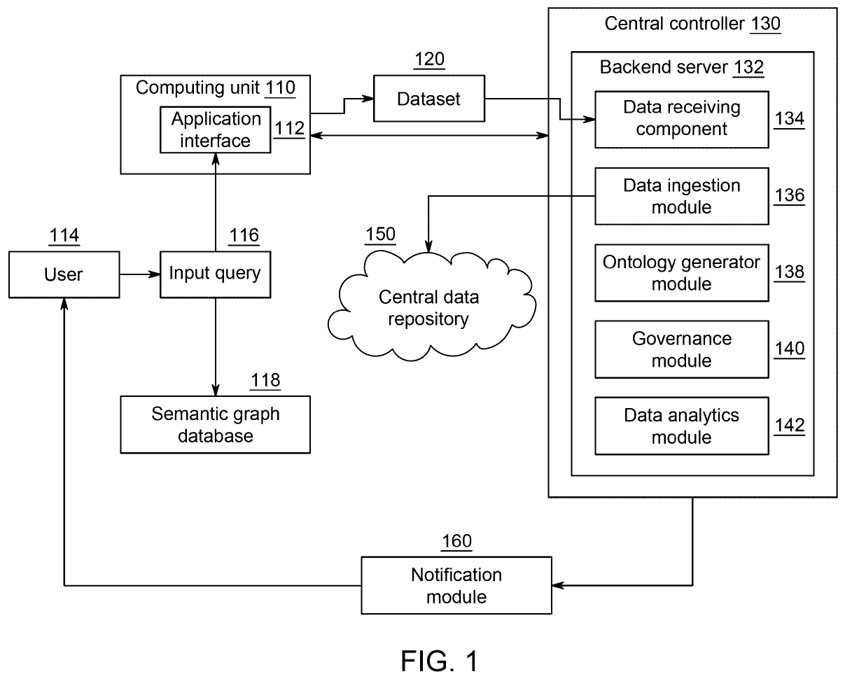

FIG. 1 depicts an exemplary document portfolio management and governance system 100.

The document portfolio management and governance system 100 is an advanced solution designed for the integrated management and governance of document portfolios. It is built on a modular architecture comprising various interconnected components, each serving a specialized function to ensure efficient data handling, compliance monitoring, and actionable insight generation. Below is a detailed explanation of each point:

The document portfolio management and governance system 100 includes a computing unit 110, which includes an application interface 112 as the primary means of interaction for users 114. The application interface 112 allows users 114 to initiate input queries 116, which can request operations such as data retrieval, analysis, or management. These input queries 116 are processed by a central controller 130 to generate actionable insights. The computing unit 110 ensures that the document portfolio management and governance system 100 remains user-friendly and accessible, offering real-time interactions for varied user demands. The input queries 116 are pivotal in driving the document portfolio management and governance system 100 operations, ensuring seamless communication between the user's intent and the backend processes.

The central controller 130 serves as the operational backbone of the document portfolio management and governance system 100. The central controller 130 includes a robust backend server 132 that connects to the computing unit's application interface 112 through a communication medium. These mediums include advanced wireless technologies such as 5G, private 5G, 6G, and Wi-Fi, alongside low-power solutions like LPWA. Peer-to-peer connections, voice interfaces (e.g., Alexa, Siri, Google Voice), and physical devices such as point-of-sale (POS) document portfolio management and governance system 100s and scanners further enhance connectivity. This comprehensive network architecture ensures the document portfolio management and governance system 100 compatibility with modern and legacy devices, facilitating seamless integration across various operational environments.

The document portfolio management and governance system 100 includes a data receiving component 134 designed to handle diverse datasets 120 sourced from enterprise databases, document repositories, cloud storage document portfolio management and governance system 100s, web services, and third-party APIs. These datasets 120 include structured data like tabular datasets (e.g., user data, financial records, inventory metrics) and logs and metrics (e.g., network logs and application performance metrics). Semi-structured data such as social media outputs, configuration files, and web services are also supported. Moreover, unstructured datasets-comprising textual information, multimedia files, and sensor data-are seamlessly ingested. These datasets 120 are received in multiple formats, including JSON, XML, CSV, PDF, and image formats like JPEG and PNG, ensuring adaptability to a broad range of data types and sources.

Once the data is received, a data ingestion module 136 processes it by detecting, normalizing, and aggregating the various elements. The data ingestion module 136 ensures data consistency by resolving discrepancies in formats and units while consolidating datasets 120 into a central data repository 150. By eliminating redundancy and structuring the dataset 120, the data ingestion module 136 prepares the dataset 120 for further processing, significantly enhancing data accessibility and usability. The centralized data repository 150 acts as the foundation for subsequent operations, providing a reliable and organized source for querying and analysis.

An ontology generator module 138 is an important component of the document portfolio management and governance system 100, dynamically categorizing and contextualizing the ingested data in real-time. The ontology generator module 138 comprises sub-modules for data aggregation, meta-tagging, schema mapping, and lineage tracking. The data aggregation sub-module consolidates datasets from structured, semi-structured, and unstructured sources into the central repository. The meta-tagging sub-module assigns metadata based on contextual relevance, facilitating efficient retrieval and analysis. The schema mapping sub-module aligns data attributes into a unified schema, enhancing interoperability across datasets. The lineage tracking sub-module maintains a historical record of data transformations, migrations, and usage, ensuring transparency and traceability. Furthermore, the ontology generator leverages natural language processing (NLP) techniques to analyze unstructured data, deriving semantic metadata and contextual insights. It dynamically updates its ontology in response to changes in data sources or elements, ensuring adaptability and relevance in evolving data environments. Collaboration with human experts refines the ontology, enhancing its accuracy and contextual depth.

A governance module 140 enforces robust data compliance policies, ensuring adherence to regulatory frameworks like GDPR, HIPAA, and ISO 27001. The governance module 140 comprises several sub-modules, each serving a distinct purpose. The compliance rule sub-module defines and enforces governance rules based on industry standards. The audit log manager sub-module generates and maintains detailed logs of data access and modifications, ensuring auditability. The data masking sub-module anonymizes sensitive fields to protect user privacy. The policy management sub-module creates, stores, and applies governance policies dynamically, adapting to operational contexts. The governance module also performs automated compliance checks, identifying and addressing gaps with corrective actions. These capabilities ensure that the document portfolio management and governance system 100 not only adheres to regulatory requirements but also promotes transparency and accountability in data handling.

A data analysis module 142 provides advanced analytical capabilities to generate actionable insights from the ingested datasets 120. These insights encompass predictive analyses, data accuracy assessments, governance status reports, operational inefficiencies, compliance gaps, risk indicators, and data integrity evaluations. The data analysis module 142 includes sub-modules for predictive analytics, fraud detection, and visualization generation. The predictive analytics sub-module applies machine learning models to forecast trends and outcomes, enabling proactive decision-making. The fraud detection sub-module identifies anomalies and patterns indicative of fraudulent activities, safeguarding organizational assets. The visualization generation sub-module creates interactive dashboards and charts, presenting complex data in a user-friendly manner. These analytical capabilities are crucial for uncovering hidden patterns, optimizing operations, and mitigating risks.

The central controller 130 integrates the insights generated by the data analysis module 142 with the governance framework, enabling automated management, monitoring, and visualization of actionable insights. These insights are displayed on the application interface 112 of the computing unit 110, ensuring that users have access to real-time, relevant information.

The integration of a semantic graph database 118 further enhances the document portfolio management and governance system 100 capabilities. The semantic graph database 118 utilizes semantic rules and graph structures to store, query, and analyze interconnected data, enabling advanced relational analyses and contextual understanding. The semantic graph database 118 adds depth to the document portfolio management and governance system 100 analytical processes, uncovering meaningful relationships that would otherwise remain hidden.

A notification module 160 ensures that users 114 are promptly informed about significant insights, anomalies, or compliance issues. Notifications are customizable based on user roles or operational priorities, delivering relevant updates to the appropriate stakeholders. For example, compliance officers may receive alerts about potential regulatory violations, while analysts are informed about emerging trends or operational inefficiencies. This targeted approach ensures that critical information is delivered to those who need it most, enhancing decision-making and responsiveness.

The document portfolio management and governance system 100 represents a sophisticated approach to managing and governing document portfolios. By integrating advanced technologies such as NLP, machine learning, and semantic graph databases 118, it provides a scalable and efficient solution for organizations across various industries.

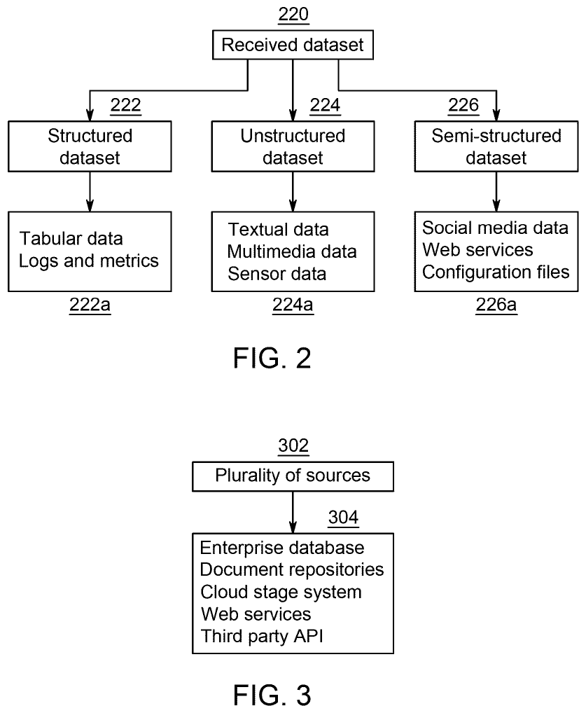

FIG. 2 depicts details of the received dataset 220 used for the generation of the insights.

The received dataset 220 comprises three primary types of data, namely, structured dataset 222, unstructured dataset 224, and semi-structured dataset 226, each playing a distinct role in data integration and analysis. These datasets are sourced from diverse systems, ensuring a detailed approach to managing information.

The structured dataset 222 is characterized by its predefined schemas, allowing for easy organization and analysis. The structured dataset 222 includes multiple data 222a, including, tabular data such as user data, financial data, and inventory data. These are sourced from relational databases, spreadsheets, and data warehouses. Additionally, the structured dataset 222 incorporates logs and metrics, such as network logs, application usage metrics, and server performance reports, which provide critical insights into system performance and operational trends.

The unstructured dataset 224 lacks a fixed format, making it more complex but rich in diverse information. The unstructured dataset 224 includes multiple data 224a, including, textual data such as text documents, PDFs, reports, emails, and chat logs, which are often critical for communication and documentation analysis. Multimedia data, including audio, video, and image files, is also part of this category, offering valuable insights for industries like media and security. Additionally, sensor data from IoT devices and various sensors is included, capturing raw environmental or operational details. These unstructured datasets 224 are received from sources such as email servers, content management systems, and sensor data repositories.

The semi-structured dataset 226 bridges the gap between structured dataset 222 and unstructured dataset 224, offering some organizational properties but lacking rigid schemas. The semi-structured dataset 226 includes multiple dataset 226a, including, social media data, such as posts and comments, as well as data from web services and APIs in formats like JSON or XML. Configuration files, including YAML and XML files, also form part of this dataset, providing structured key-value pairs that require parsing. The semi-structured data 226 is sourced from social media platforms, web-based APIs, and other dynamic sources.

These three types of datasets collectively create a strong framework for data integration, enabling advanced analytics by combining structured precision, unstructured richness, and semi-structured flexibility.

FIG. 3 depicts details of the plurality of sources 302 from where the dataset is received.

The dataset is received from plurality of sources 302, which includes multiple databases 304 designed to provide structured, unstructured, and semi-structured data for analysis. This plurality of sources 302 include multiple databases such as enterprise databases, document repositories, cloud storage systems, web services, and third-party APIs, each contributing to the diversity and comprehensiveness of the dataset.

One of the primary sources 302 is enterprise databases, which act as centralized systems for managing structured, business-critical information. These databases store data such as customer profiles, financial transactions, inventory records, and operational metrics. Enterprise databases ensure data consistency, accessibility, and security, making them a reliable foundation for structured data.

Document repositories serve as another critical source, providing a secure and organized space for storing unstructured data. These repositories manage documents such as reports, contracts, PDFs, manuals, and other textual records. They enable efficient storage and retrieval of information while maintaining document lineage and version control, ensuring that data is accurate and accessible.

Cloud storage systems offer a scalable solution for handling large volumes of data. These systems store diverse types of data, including multimedia files, sensor outputs, and application backups. Cloud storage enables seamless access to data from remote locations, supports disaster recovery efforts, and integrates with various tools for advanced data processing and analytics.

Web services provide dynamic and real-time data, often accessed through APIs using standard communication protocols such as REST or SOAP. These services supply metadata, logs, or live feeds relevant to the organization's operations, offering flexibility in integrating real-time information into analytical workflows.

Third-party APIs act as gateways to external data sources, providing access to specialized datasets such as market trends, social media analytics, financial indices, or weather updates. These APIs extend the system's capabilities by enabling the inclusion of external insights and services into the dataset.

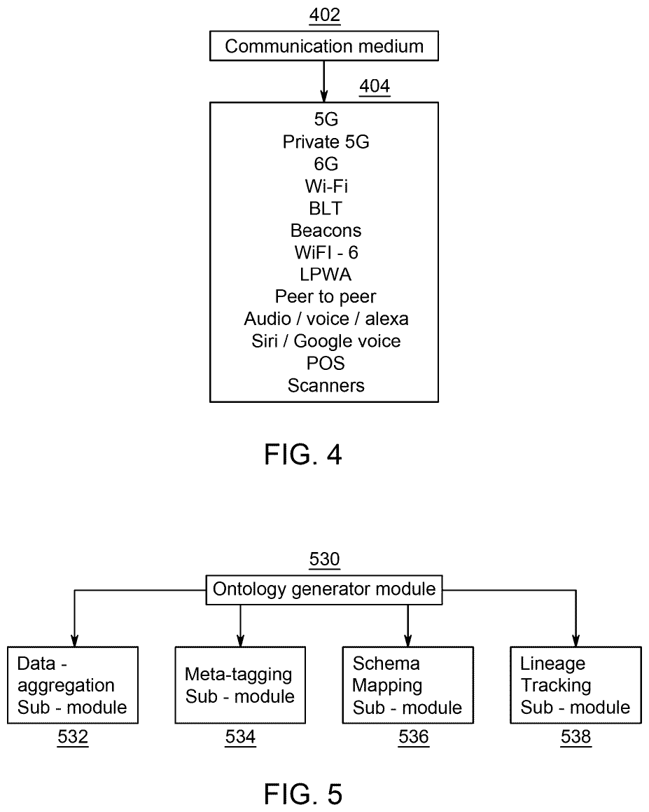

FIG. 4 depicts a communication medium 402 used to establish a communicable connection between the backend server and the application interface.

The backend server is communicably connected to the application interface through the communication medium 402, which serves as the channel for data transmission and interaction. This communication medium 402 is not limited to a single type but encompasses multiple advanced and traditional technologies 404 to ensure seamless connectivity and operational flexibility. Among the various types of communication mediums is 5G, a next-generation network offering high-speed, low-latency connectivity for handling large volumes of data in real-time. Additionally, private 5G networks provide secure and dedicated connectivity solutions tailored to enterprise needs, ensuring enhanced security and reliability.

Emerging technologies like 6G promise ultra-low latency and even faster data rates, pushing the boundaries of real-time processing and communication. Standard wireless protocols such as Wi-Fi and Wi-Fi-6 are also included, with Wi-Fi-6 offering improvements in speed, efficiency, and capacity, particularly in environments with dense device usage.

Other communication mediums 402 include Bluetooth (BLT) and beacons, which facilitate short-range communication for applications like location tracking, proximity-based services, and device pairing. Low Power Wide Area (LPWA) networks are integrated to support IoT devices by enabling long-range communication with low power consumption, ideal for sensor-based ecosystems.

The system also supports peer-to-peer (P2P) communication, allowing direct interaction between devices without requiring a centralized server. Audio and voice-based communication channels are included, catering to natural language interfaces and applications requiring auditory interactions. Virtual assistants such as Alexa, Siri, and Google Voice further enhance communication by providing voice-activated interfaces for accessing and managing data or applications.

For retail and transactional systems, the communication mediums 402 extend to Point of Sale (POS) systems and scanners, ensuring streamlined data exchange for inventory management, billing, and customer engagement. By integrating this diverse array of communication mediums 402, system 100 provides robust and flexible connectivity, catering to various operational needs and technological environments.

FIG. 5 depicts various sub-modules of the ontology generator module 530.

The ontology generator module 530 comprises multiple specialized sub-modules, each performing a critical function to facilitate the creation of a structured and meaningful data ontology. These sub-modules work together to aggregate, organize, and contextualize data while ensuring traceability and usability for advanced analytics. The ontology generator module 530 includes various sub-modules namely, a data aggregation sub-module 532, a meta-tagging sub-module 534, a schema mapping sub-module 536, and a lineage tracking sub-module 538.

The data aggregation sub-module 532 is responsible for collecting and consolidating data from structured, unstructured, and semi-structured sources into a centralized repository. For example, the data aggregation sub-module 532 gathers structured data such as customer records from relational databases, unstructured data like text documents and multimedia files from document repositories or cloud storage, and semi-structured data such as JSON logs from APIs or social media platforms. The data aggregation sub-module 532 ensures that all data, regardless of its origin or format, is made accessible and ready for further processing.

The meta-tagging sub-module 534 assigns meta-tags to individual data points based on content analysis, context, and relevance. For instance, a financial transaction record might be tagged with attributes such as “transaction ID,” “customer ID,” “amount,” and “timestamp,” while a multimedia file could receive tags like “file type,” “subject,” and “capture location.” This tagging enhances the ability to filter, search, and retrieve data efficiently, as well as to categorize information for specific use cases like compliance reporting or trend analysis.

The schema mapping sub-module 536 aligns data attributes and relationships into a unified schema, creating a standardized framework for interpreting data across disparate sources. For example, customer data stored in different formats across multiple databases, such as relational tables, XML files, or NoSQL databases, is matched to a consistent schema with standardized fields like “name,” “email,” “phone,” and “purchase history.” This ensures interoperability and facilitates seamless integration of data from mixed systems.

The lineage tracking sub-module 538 maintains a history of data transformations, migrations, and usage across the system. For example, the lineage tracking sub-module 538 can record the origin of a specific dataset, document modifications made during data cleaning or transformation processes, and track the downstream applications or reports where the data has been used. This capability is vital for ensuring data transparency, supporting regulatory compliance, and enabling root cause analysis in case of discrepancies or errors.

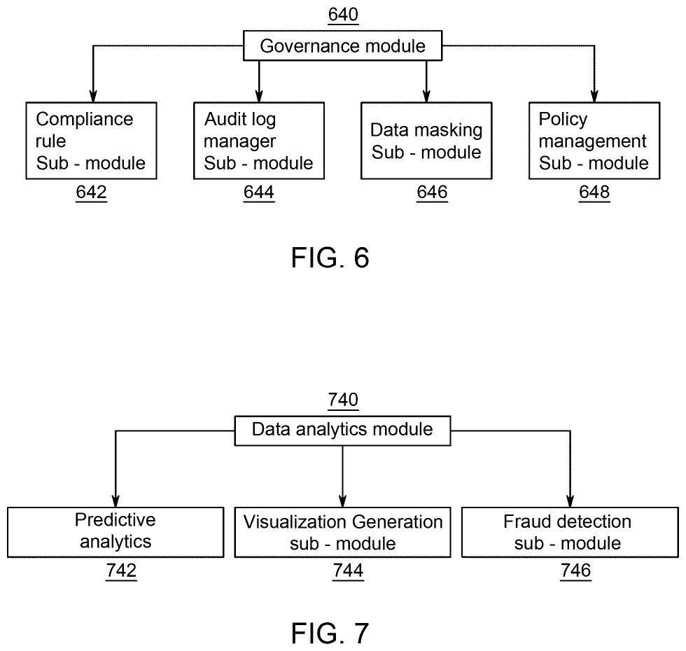

FIG. 6 depicts various sub-modules of the governance module 640.

The governance module 640 is a crucial component of the system 100, designed to ensure compliance, security, and effective management of data throughout its lifecycle. The governance module 640 includes several specialized sub-modules that work together to enforce governance policies, track data access, and protect sensitive information, ensuring that all actions align with regulatory and organizational standards. These sub-modules include a compliance rule sub-module 642, an audit log manager sub-module 644, a data masking sub-module 646, and a policy management sub-module 648.

The compliance rule sub-module 642 is responsible for defining and enforcing rules for data governance based on various regulatory and industry standards. For example, compliance rule sub-module 642 ensures that data management practices comply with frameworks such as the General Data Protection Regulation (GDPR), Health Insurance Portability and Accountability Act (HIPAA), or the Sarbanes-Oxley Act. The compliance rule sub-module 642 can establish rules related to data retention periods, access controls, and data usage, ensuring that the organization adheres to the legal and regulatory obligations specific to its industry. The compliance rule sub-module 642 automatically checks incoming data or actions against these predefined rules, ensuring continuous compliance.

The audit log manager sub-module 644 plays a key role in tracking and documenting every interaction with data. The audit log manager sub-module 644 generates and maintains detailed logs of all data access, modifications, and governance actions, which are essential for auditability. For example, whenever a user accesses, edits, or deletes a file, or when a governance policy is applied, the audit log records these actions, noting the user, timestamp, and nature of the change. This log is invaluable for compliance audits, security investigations, and tracing data-related activities, ensuring full transparency and accountability within the system.

The data masking sub-module 646 is designed to protect sensitive data by anonymizing specific fields to comply with privacy regulations. For instance, data masking sub-module 646 can mask personally identifiable information (PII) such as social security numbers, credit card details, or health records, ensuring that only authorized personnel can access the full data. Data masking helps prevent unauthorized exposure of sensitive information, safeguarding both individuals' privacy and organizational security. The data masking sub-module 646 is essential for systems that handle private or regulated data, ensuring that privacy laws such as GDPR are strictly followed.

The policy management sub-module 648 is responsible for creating, storing, and dynamically applying governance policies based on operational contexts. The policy management sub-module 648 allows for the flexible creation of policies that can be personalized to specific business needs, legal requirements, or operational conditions. For example, a policy might specify stricter data access controls for users handling financial records during tax season or enforce more rigorous encryption standards for data transmitted across public networks. The policy management sub-module 648 ensures that governance policies are always relevant and adaptable to changing circumstances, maintaining data integrity and compliance across various scenarios.

FIG. 7 depicts various sub-modules of the data analytics module 740.

The data analytics module 740 plays a pivotal role in transforming raw data into actionable insights that drive informed decision-making across the organization. The data analytics module 740 consists of several sub-modules that enable advanced data analysis, visualization, and the detection of operational inefficiencies or fraudulent activities. The sub-modules within the data analytics modules 740 include various sub-modules, namely, a predictive analytics sub-module 742, a visualization generation sub-module 744, and a visualization generation sub-module 744. These sub-modules work together to deliver a comprehensive understanding of data, focusing on predictive analysis, visual representation, and identifying risks or compliance gaps.

The predictive analytics sub-module 742 applies machine learning models to the data, helping to identify emerging trends, forecast potential outcomes, and make data-driven predictions. For example, predictive analytics sub-module 742 might analyze historical sales data to predict future revenue or evaluate user behavior patterns to forecast churn rates. The predictive analytics sub-module 742 enables the organization to anticipate changes, prepare for future scenarios, and make proactive decisions. The insights derived from predictive analytics could highlight operational inefficiencies, potential risks, or areas where performance improvements are needed, empowering decision-makers to take timely and informed actions.

The visualization generation sub-module 744 focuses on creating interactive charts, graphs, and dashboards based on the analyzed data. The visualization generation sub-module 744 takes complex data sets and translates them into visually engaging formats, allowing users to easily interpret and explore the information. For instance, the visualization generation sub-module 744 might generate a dashboard that shows key performance indicators KPIs such as sales trends, customer engagement metrics, or operational efficiency. These visual tools make it easier for users to identify patterns, trends, and anomalies, enabling a clearer understanding of business performance at a glance. By offering interactive capabilities, the visualization generation sub-module 744 allows users to drill down into specific areas of interest, further enhancing the depth of analysis and insight.

The fraud detection sub-module 746 is designed to identify anomalies and patterns within the data that may indicate fraudulent activities. For example, the fraud detection sub-module 746 might flag unusual transactions or identify suspicious patterns of behavior, such as irregular spending habits or unauthorized access to sensitive information. By analyzing both structured and unstructured data sources, the fraud detection sub-module 746 can detect fraud indicators across a wide range of data points, such as financial transactions, customer interactions, or employee activity logs. The fraud detection sub-module 746 plays a critical role in maintaining the integrity of data and operations, safeguarding the organization against potential financial losses or reputational damage due to fraudulent activities.

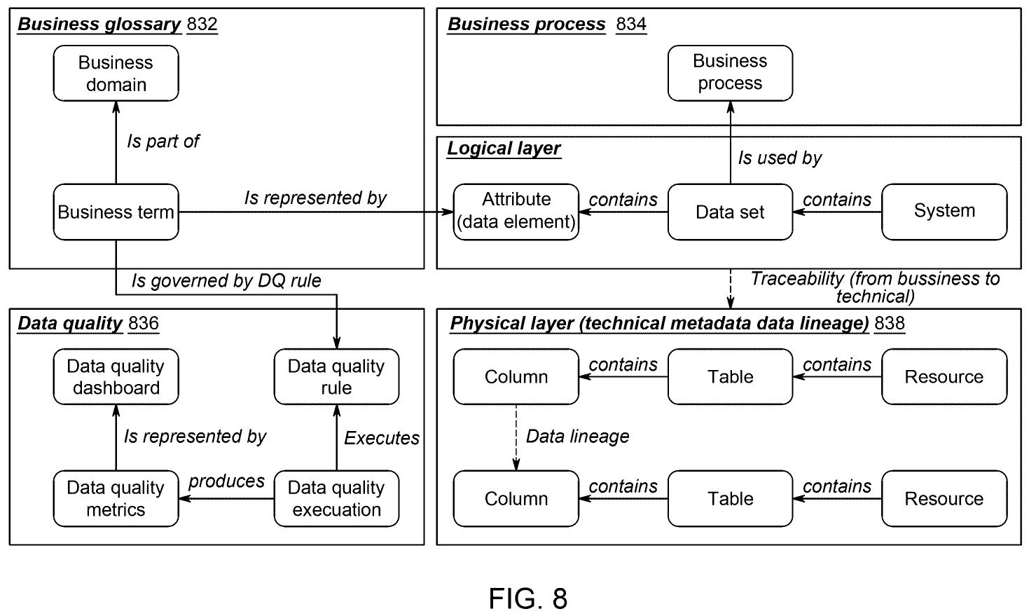

FIG. 8 depicts details of the dataset enabled by the metadata 830.

The dataset enabled by metadata 830 consists of multiple interconnected layers that contribute to the organization, management, and overall integrity of data within an enterprise. These layers include the business glossary 832, business process 834, data quality 836, and physical layer 838, each serving a distinct but essential function in ensuring the data is accurate, well-organized, and aligned with the business objectives.

The business glossary 832 serves as the foundational reference for understanding and defining the terminology used within the business. It includes a comprehensive list of terms and concepts relevant to the organization's operations. For example, terms such as “customer,” “order,” “product,” and “sales” are clearly defined in the glossary to ensure that everyone within the organization shares a common understanding of what these terms mean. This glossary not only aids in standardizing communication across different teams but also incorporates a business team, which is responsible for maintaining the glossary and ensuring that the terms are aligned with the business context. The business team plays a crucial role in reviewing and updating the glossary, ensuring that the terms used are reflective of the organization's evolving practices and requirements. By maintaining a clear and consistent vocabulary, the business glossary 832 enables more effective data governance, communication, and alignment across business units.

The business process 834 layer is focused on how the metadata 830 is used within specific operational workflows across the organization. This sub-layer links the data to its practical use in executing business tasks or achieving organizational goals. For example, a business process 834 for “customer order management” would rely on datasets that include information such as customer profiles, order details, payment status, and shipping information. The dataset associated with this process includes specific data attributes, such as “customer name,” “order amount,” and “product type,” each of which is defined and managed by the business team. The business team ensures that the data attributes are correctly linked to the business process 834 and provide value for operational decision-making. The business process 834 layer thus transforms raw data into actionable information that directly supports the workflow and operations of the business, driving efficiency and performance.

The data quality 836 layer ensures that the dataset used across the organization is reliable, accurate, and usable. This layer encompasses data quality metrics, which are criteria used to assess the state of the data, such as its accuracy, completeness, consistency, and timeliness. These metrics are tracked using a data quality dashboard, a tool that provides visual indicators of how well the data adheres to established standards. For example, the dashboard might show that 95% of customer records are complete, while 5% are missing essential details like email addresses. The metrics are generated by data quality execution, a process that applies predefined data quality rules to the datasets. These rules are typically defined by the business team, ensuring they reflect both regulatory standards and the specific needs of the business. For instance, a data quality rule might require that all customer orders must include both a billing address and a shipping address. If data fails to meet these standards, it is flagged for review, ensuring that only high-quality, reliable data is used in business processes.

The physical layer 838 represents the actual storage structure of the metadata 830, providing the technical framework that organizes the data within databases. This layer includes tables and columns, which represent how data is stored and indexed within the system 100. For example, in the physical layer 838, a table might be created for “customers,” with columns such as “customer_id,” “first_name,” “last_name,” “email_address,” and “phone_number.” These tables and columns serve as the structural foundation for data access and analysis, enabling users to query and manipulate data for reporting, analysis, or other business purposes. The physical layer 838 is critical for ensuring that data is stored efficiently and can be accessed quickly by both technical systems and end-users. It allows for the transformation of raw, unorganized data into a well-structured format that supports business applications, reporting, and analytics.

The dataset enabled by metadata 830 provides a multi-layered framework for managing and utilizing data across the organization. The business glossary 832 ensures that terms are standardized and well-understood, while the business process 834 layer links data to specific operational workflows. The data quality 836 layer monitors and maintains the integrity of the data, ensuring it is accurate and reliable, and the physical layer provides the underlying storage and structure for data access and analysis.

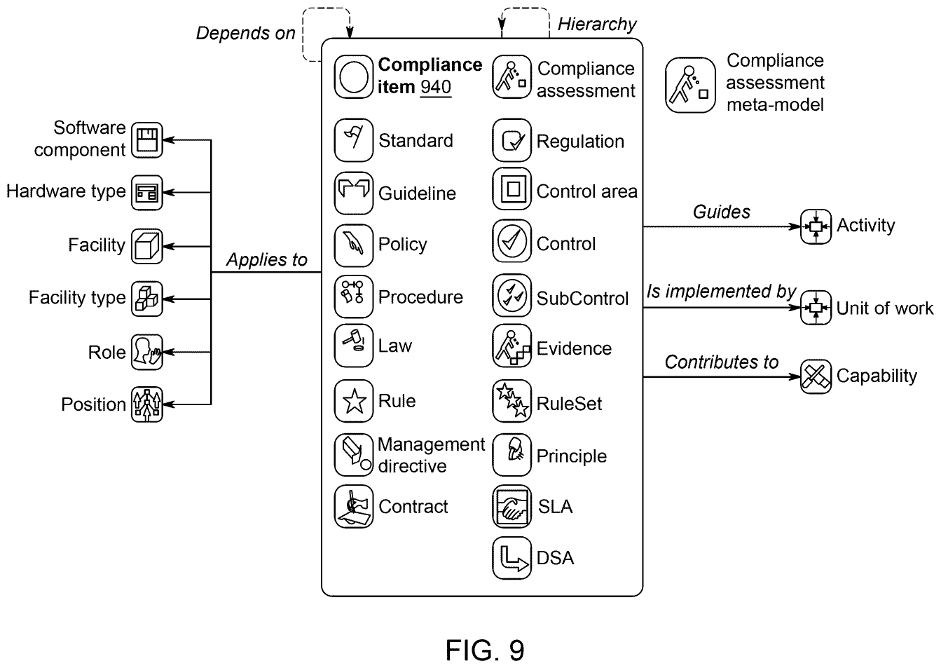

FIG. 9 depicts details of compliance policies 940 to define and enforce rules for data governance based on regulatory and industry standards.

The compliance item 940 represents a comprehensive framework of components necessary for ensuring regulatory and operational compliance within an organization. Compliance items 940 encompass a wide range of elements such as standards, guidelines, policies, procedures, laws, rules, management directives, and contracts. Each compliance item 940 serves a specific purpose in governing how activities and processes are carried out, ensuring alignment with both internal governance requirements and external regulatory mandates. For example, a policy may outline the organization's approach to data protection, while a law could refer to compliance with the General Data Protection Regulation (GDPR). Similarly, a management directive might specify how to handle confidential customer data. The compliance items 940 collectively form the foundation of an organization's compliance strategy, enabling a structured and consistent approach to managing obligations across various domains.

The compliance assessment expands on these compliance items 940 by incorporating additional elements such as regulations, control areas, controls, sub-controls, evidence, rule sets, principles, service-level agreements (SLAs), and data-sharing agreements (DSAs). The compliance assessment framework is designed to evaluate the organization's adherence to defined compliance items. For instance, a regulation might require maintaining a specific level of data encryption, which is assessed under a relevant control area like “Data Security.” Within this control area, controls and sub-controls define specific actions or safeguards, such as encrypting data at rest and in transit. Evidence, such as audit logs or access reports, is gathered to validate compliance. Additionally, rule sets and principles guide the implementation of compliance measures, while SLAs and DSAs ensure that third-party agreements are aligned with organizational policies. This layered approach to compliance assessment ensures that every aspect of regulatory and operational obligations is thoroughly examined and documented.

Compliance item 940 applies across various domains, including software components, hardware types, facilities, facility types, roles, and positions within the organization. For example, a compliance item 940 like a security guideline might apply to specific software components, such as database systems, requiring regular updates and vulnerability assessments. Similarly, compliance item 940 like a policy on workplace safety could apply to facilities or facility types, such as manufacturing plants or office buildings, ensuring adherence to safety protocols. Roles and positions, such as system administrators or data protection officers, may also be governed by compliance items that specify responsibilities like maintaining secure configurations or overseeing data privacy measures.

Furthermore, the compliance assessment serves as a critical tool for guiding organizational activities, implementing units of work, and contributing to overall capabilities. For example, a compliance assessment related to a financial regulation might guide activities such as quarterly reporting or transaction audits. These activities are implemented through specific units of work, such as generating financial statements or conducting internal audits. Over time, these assessments contribute to the organization's overall capabilities, such as improving risk management, enhancing operational efficiency, and ensuring sustained compliance with evolving regulations. By providing a structured and actionable approach, the compliance assessment ensures that compliance is not only maintained but also integrated into the organization's broader operational strategy.

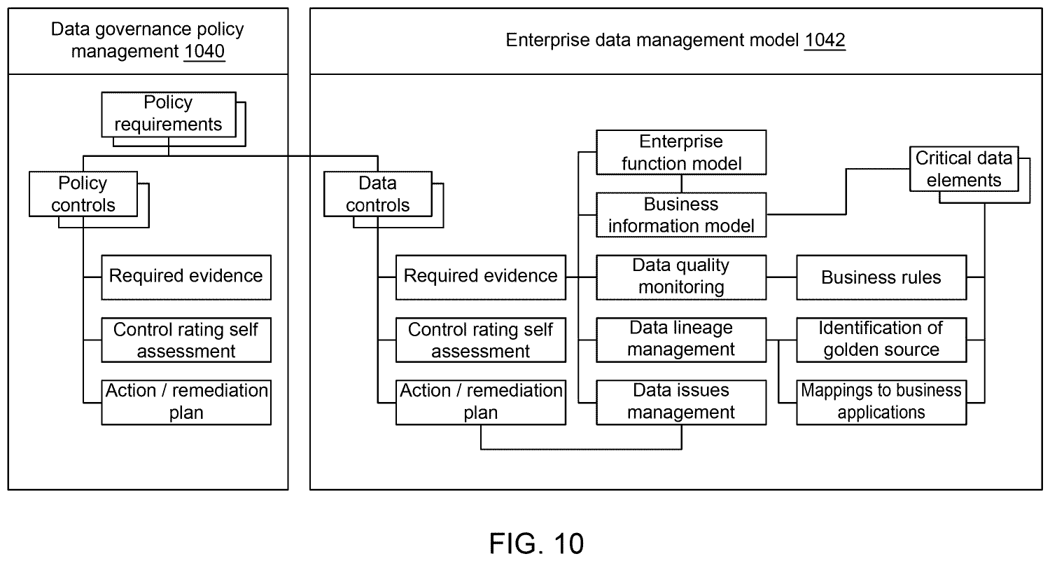

FIG. 10 depicts details of the governance policies adapted to enforce & monitor data compliance policies.

The governance policies designed to enforce and monitor data compliance policies are central to ensuring that an organization's data is managed responsibly and in accordance with regulatory and operational standards. These governance policies encompass two key components, namely, data governance policy management 1040 and the enterprise data management model 1042. Together, these components provide a detailed framework for defining, implementing, and overseeing data compliance processes, thereby promoting accountability, transparency, and consistency across the organization.

The data governance policy management 1040 focuses on the creation and enforcement of policy requirements that include both policy controls and data controls. Policy controls are mechanisms designed to ensure adherence to governance policies through structured processes. These controls include the identification of required evidence, such as documentation or audit trails, that validate compliance with specific policies. For example, to comply with a policy on data retention, required evidence might include storage logs or confirmation of data deletion after a defined period. Additionally, control rating self-assessments enable teams or individuals to evaluate their adherence to policy controls, identifying strengths and gaps in compliance. Where gaps are identified, an action plan is developed to address deficiencies, outlining steps, timelines, and responsibilities for achieving compliance. These processes ensure that governance policies are actively enforced and monitored rather than existing merely as static documents.

The enterprise data management model 1042 complements this by providing a structured approach to managing data controls, which are essential for ensuring the integrity, quality, and usability of data across the organization. These controls include the enterprise function model, which defines organizational roles and responsibilities for data management, ensuring that every function aligns with overarching governance objectives. The business information model provides a conceptual framework for understanding how data flows through various business processes, facilitating better integration and communication across departments. Data quality monitoring ensures that data meets predefined standards, such as accuracy, completeness, and timeliness, through continuous evaluation and reporting. For instance, dashboards might highlight anomalies in data entries that require immediate attention.

Another critical component of the enterprise data management model 1042 is data lineage management, which tracks the origin, transformations, and destinations of data throughout its lifecycle. This capability enhances transparency and allows organizations to trace errors or inconsistencies back to their source, ensuring accountability. Data issue management establishes processes for identifying, logging, and resolving data-related problems, such as missing or incorrect entries, while maintaining records of resolutions for audit purposes. Business rules further reinforce governance by defining specific criteria and conditions under which data is processed, such as rules for validating customer addresses or formatting financial transactions.

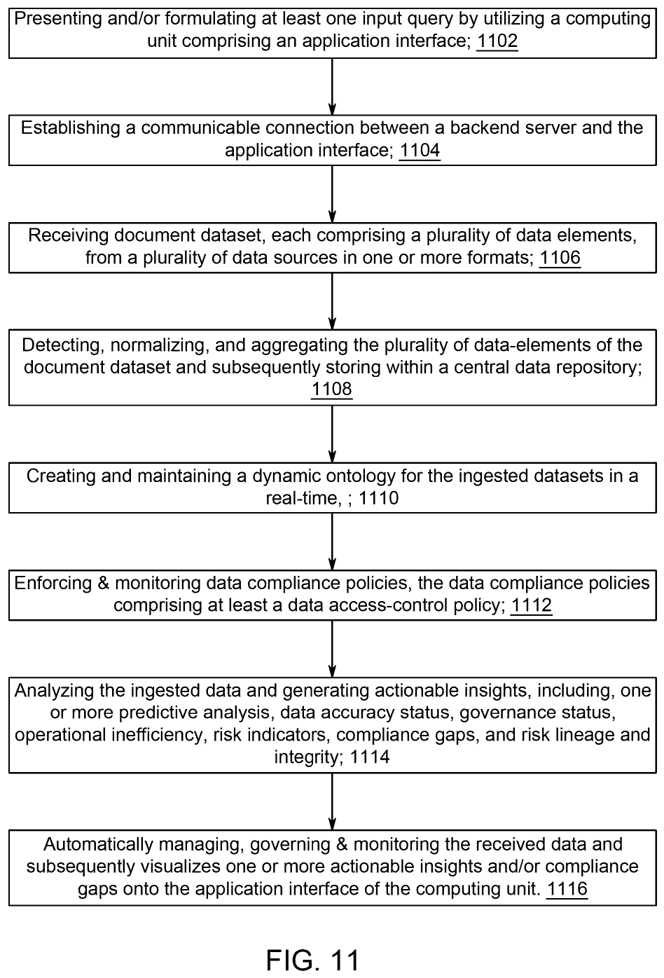

FIG. 11 depicts an exemplary document portfolio management and governance process 1100.

The document portfolio management and governance process 1100 is explained below in detail:

Step 1102 involves presenting and/or formulating at least one input query by utilizing a computing unit comprising an application interface.

The step of presenting and/or formulating at least one input query begins with a user initiating a request through an application interface. The first step involves the user defining their objective, which could range from retrieving specific document data, analyzing datasets for actionable insights, or managing data compliance requirements. The input query is crafted based on these objectives, incorporating parameters such as the type of data needed, the scope of analysis, or specific compliance rules to be checked.

Once the query is defined, the user specifies additional details like keywords, date ranges, or datasets to refine the request. For example, a compliance officer might input a query to review documents for adherence to data privacy regulations, while a business manager may request a report on operational inefficiencies from financial logs.

The input query is then translated into a format that can easily be understood, with the application interface automatically interpreting user inputs into structured commands. This ensures the input query aligns with the technical requirements of the backend operations while preserving the user's intent. For instance, if a user types a natural language question such as “Show me compliance gaps in financial records for Q1,” the interface processes this input into a structured query specifying the relevant dataset and time frame.

Once the input query is formulated, it is executed by a backend central controller, which begins by locating the relevant data from a central repository. The step includes identifying the required datasets, which could include structured data like financial logs, unstructured data like PDF reports, or semi-structured data such as social media comments. The dataset is then analyzed to address the query, applying advanced analytics techniques where necessary.

For instance, in the case of a fraud detection query, the process involves scanning financial datasets, detecting anomalies, and analyzing patterns indicative of potential fraud. Similarly, a compliance assessment query might involve checking datasets against predefined regulatory rules, identifying gaps, and categorizing non-compliant data points.

Finally, the results of the input query are processed and presented back to the user in an actionable format. This could include visual dashboards for trends and insights, detailed reports highlighting compliance gaps, or recommendations for addressing operational inefficiencies. For example, the process may produce a chart displaying non-compliance trends over time or a summary report of flagged transactions for further review.

Step 1104 involves establishing a communicable connection between a backend server and the application interface.

Establishing a communicable connection between the backend server and the application interface is a critical step that ensures seamless data exchange and functionality. This step involves setting up a reliable and efficient communication medium that links the backend server, which handles data processing and storage, with the user-facing application interface. The communication medium employed in this setup is versatile and incorporates various advanced technologies to cater to different use cases and environments.

The communication mediums include cutting-edge wireless technologies such as 5G and private 5G, which enable high-speed and low-latency data transfer, ideal for applications requiring real-time responsiveness. For future-proofing, 6G technology is also supported, offering ultra-fast connectivity and enhanced bandwidth for next-generation applications. Standard wireless options like Wi-Fi, Wi-Fi 6, and Bluetooth (BLT) provide flexible and widely compatible connectivity solutions, ensuring accessibility for users across various devices and networks.

To accommodate unique connectivity requirements, the system supports LPWA (Low-Power Wide-Area) networks, which are particularly useful for IoT devices and applications requiring long-range, energy-efficient Peer-to-peer communication protocols facilitate direct connections between devices without relying on central hubs, enhancing efficiency in localized data sharing.

The communication framework is further enriched by integrating audio and voice-based technologies, allowing interaction through natural language commands via platforms like Alexa, Siri, and Google Voice. This ensures intuitive and hands-free operation for users, streamlining workflows. Additionally, the specialized hardware interfaces such as point-of-sale (POS) systems and scanners, enable seamless integration with business operations and transactional workflows.

Step 1106 involves receiving document datasets, each comprising a plurality of data elements, from a plurality of data sources in one or more formats.

The step begins by receiving document datasets, each comprising a variety of data elements collected from diverse sources and presented in multiple formats. These datasets fall into three categories: structured, semi-structured, and unstructured. Structured datasets are well-organized and include tabular data such as user profiles, financial transactions, and inventory records, along with logs and metrics that capture network performance, application usage, and server operations. These structured datasets are often sourced from relational databases, spreadsheets, and data warehouses.

Semi-structured datasets represent a blend of organization and flexibility, including event data, social media posts, comments, web service outputs, and configuration files. They may come from social media platforms, APIs, or monitoring tools and are characterized by having some level of structure but not conforming to rigid schemas. Unstructured datasets are the most diverse, encompassing textual content like emails, reports, and chat logs; multimedia files such as audio recordings, videos, and images; and raw sensor data generated by IoT devices. These datasets are sourced from content management systems, cloud storage platforms, and real-time data feeds. The datasets are received in formats ranging from text files, JSON, XML, and CSV to PDFs and image formats like JPEG and PNG, ensuring compatibility with various data types.

Step 1108 involves detecting, normalizing, and aggregating the plurality of data elements of the document dataset and subsequently storing them within a central data repository.

Following data receipt, the data elements are detected, normalized, and aggregated. Detection involves identifying and isolating relevant data points within the dataset, ensuring that only useful information is processed. This may include filtering out unnecessary records or extracting specific attributes from semi-structured and unstructured data. Normalization focuses on standardizing the data format to ensure consistency across different datasets. For example, dates might be reformatted to a uniform structure, or duplicate entries might be consolidated to avoid redundancy.

Aggregation then combines these normalized data elements into a unified structure within the central data repository. By merging information from various sources, the system creates a comprehensive, centralized view of the data, eliminating silos and enabling efficient access for subsequent analysis. This repository acts as a secure, scalable hub where the prepared data is stored and maintained for further operations, ensuring that downstream processes can operate on high-quality and well-organized datasets.

Step 1110 involves creating and maintaining a dynamic ontology for the ingested datasets in a real-time.

The dynamic ontology is created and maintained by using the ingested datasets in real-time. This involves categorizing and contextualizing the data elements based on their attributes and relationships, thereby enabling an organized representation of the data. The ontology dynamically evolves to accommodate changes in data structure, content, or usage patterns. Machine learning techniques are applied to support this process, with meta-tagging automatically assigning and updating metadata to reflect shifts in context or structure.

For example, if new social media data is ingested, the ontology is updated to recognize relevant tags and relationships, ensuring seamless integration with existing datasets. By maintaining this dynamic ontology, the system provides a robust framework for understanding and navigating the data, forming the backbone of accurate analysis and actionable insights. The dynamic nature of the ontology ensures that it adapts to organizational needs and evolving data landscapes.

Step 1112 involves enforcing & monitoring data compliance policies, the data compliance policies comprising at least a data access-control policy.

Enforcing and monitoring data compliance policies is a critical step to ensure that organizational data practices align with regulatory requirements, industry standards, and internal governance frameworks. This step involves implementing data access-control policies to define who can access, modify, or share specific datasets. For instance, sensitive information such as customer financial records or employee details may only be accessible to authorized personnel with the appropriate credentials. These policies are enforced through role-based access controls, encryption protocols, and regular audits.

Monitoring mechanisms continuously track data usage to identify and address any deviations from compliance requirements. Alerts are generated if unauthorized access, data breaches, or policy violations are detected, prompting immediate corrective actions. For example, if a non-compliant data transfer occurs, the system can automatically revoke access and notify the responsible teams. This robust compliance framework protects sensitive data, ensures privacy regulations such as GDPR or HIPAA are adhered to, and provides an auditable trail of all data governance activities.

Step 1114 involves analyzing the ingested data and generating actionable insights, including, one or more predictive analysis, data accuracy status, governance status, operational inefficiency, risk indicators, compliance gaps, and risk lineage and integrity.

The next step involves analyzing the ingested data to generate actionable insights that empower decision-making and improve organizational efficiency. This analysis leverages advanced machine learning models and statistical techniques to process structured, semi-structured, and unstructured datasets stored in the central repository. Predictive analytics identifies trends and forecasts outcomes, such as potential sales increases based on historical purchase patterns. Data accuracy analysis evaluates the integrity and reliability of datasets, highlighting any discrepancies or errors.

Governance status is assessed to ensure adherence to established policies, while operational inefficiencies are identified through detailed performance metrics and system diagnostics. Additionally, the analysis reveals risk indicators and compliance gaps, providing insights into vulnerabilities in the data ecosystem. For example, a compliance gap analysis might indicate missing documentation required for regulatory audits. Finally, the process evaluates data lineage and integrity, tracing the flow of data across processes to ensure accountability and transparency. These insights are then presented through intuitive visualizations, such as dashboards and reports, enabling stakeholders to make informed decisions and address identified challenges proactively.

Step 1116 involves automatically managing, governing & monitoring the received data and subsequently visualizing one or more actionable insights and/or compliance gaps onto the application interface of the computing unit.

To ensure regulatory adherence and operational integrity, the data compliance policies are enforced and monitored. These policies include data access-control mechanisms, defining who can view, modify, or share the data. For example, access to sensitive financial records might be restricted to authorized personnel, while anonymized data could be made accessible for broader analytical purposes. Monitoring mechanisms continuously assess compliance, ensuring that all actions align with predefined policies and regulatory standards. Non-compliance triggers alerts and initiates remediation actions, safeguarding the organization against legal and operational risks.

### INDUSTRIAL APPLICATIONS

The industrial application of this invention is vast, addressing challenges across multiple sectors that rely heavily on managing and analyzing large-scale document portfolios. Its ability to integrate data from disparate sources, enhance governance, and streamline analysis makes it a valuable tool for modern organizations.

In the finance industry, the invention can optimize processes such as compliance reporting, audit preparation, and fraud detection. It simplifies the management of complex data sets in areas like loan underwriting, insurance claims, and investment analysis. By providing accurate, structured data, it ensures faster decision-making while minimizing risks.

In healthcare, the invention offers significant benefits for patient data management, regulatory compliance, and medical research. Hospitals and clinics can use it to unify electronic health records, improve data accuracy, and adhere to strict data privacy standards. Researchers can also gain faster access to structured information, accelerating discoveries and improving outcomes.

The legal sector can leverage the system to manage contracts, case files, and regulatory documents. Its advanced search and retrieval capabilities ensure quicker discovery processes, while its robust governance features help legal professionals maintain compliance with dynamic legal and regulatory requirements.

For government agencies, the invention supports policy development, regulatory oversight, and efficient handling of sensitive information. By providing a unified framework for data management, it enhances transparency, accountability, and informed decision-making across diverse governmental functions.

In addition to these sectors, the invention applies to industries like retail and manufacturing, where it can streamline operations by enabling cross-functional data analysis. It supports supply chain optimization, compliance with environmental and safety regulations, and data-driven strategic planning.

The embodiments herein and the various features and advantageous details are explained concerning the non-limiting embodiments in the following description. Descriptions of well-known components and processing techniques are omitted to not unnecessarily obscure the embodiments herein. The examples used herein are intended merely to facilitate an understanding of how the embodiments herein may be practiced and to further enable those of skill in the art to practice the embodiments herein. Accordingly, the examples should not be construed as limiting the scope of the embodiments herein.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles, or the like that has been included in this specification is solely to provide a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions, or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

We claim:

1. A system for integrated management and governance of a document portfolio, the system comprising:
a computing unit comprising an application interface adapted to present and/or formulate at least one input query;
a central controller comprising a backend server communicably connected to the application interface of the computing unit, the backend server comprising:
a data receiving component adapted to receive document dataset, each comprising a plurality of data elements, from a plurality of data sources in one or more formats;
a data ingestion module adapted to detect, normalize, and aggregate the plurality of data elements of the document dataset and subsequently store them within a central data repository;
an ontology generator module adapted to create and maintain a dynamic ontology for the ingested datasets in real-time, wherein the plurality of data elements is categorized and contextualized in accordance with the dynamic ontology;
a governance module adapted to enforce & monitor data compliance policies, the data compliance policies comprising at least a data access-control policy;
a data analysis module adapted to analyze the ingested data and generate actionable insights, wherein the actionable insights include one or more predictive analysis, data accuracy status, governance status, operational inefficiency, risk indicators, compliance gaps, and risk lineage and integrity; and
characterized in that the central controller is configured to automatically manage, govern & monitor the received data and subsequently visualize one or more actionable insights and/or compliance gaps onto the application interface of the computing unit.

2. The system of claim 1, wherein at least one input query comprises a request initiated through the application interface to retrieve, analyze, or manage document data, the request being executed by the central controller to generate actionable insights.

3. The system of claim 1, wherein the plurality of sources, include but is not limited to enterprise databases, document repositories, cloud storage systems, web services, and third-party APIs.

4. The system of claim 1, wherein the dataset is received in formats comprising text, JSON, XML, CSV, PDF, and image-based formats such as JPEG and PNG.

5. The system of claim 1, wherein the backend server is communicably connected to the application interface via., a communication medium that includes 5G, private 5G, 6G, Wi-Fi, BLT and beacons, WiFi-6, LPWA, Peer to Peer, Audio, Voice, Alexa, Siri, Google Voice, POS, and Scanners.

6. The system of claim 1, wherein the ontology generator module further comprises:
a data aggregation sub-module, adapted to collect and consolidate data from structured, unstructured, and semi-structured sources into the centralized repository;
a meta-tagging sub-module, adapted to assign meta-tags to data points based on content analysis, context, and relevance;
a schema mapping sub-module, adapted to align data attributes and relationships into a unified schema;
a lineage tracking sub-module adapted to maintain a history of data transformations, migrations, and usage across.

7. The system of claim 1 wherein the ontology generator module is further configured to dynamically update the ontology based on changes in the ingested datasets, including the addition of new data sources or modifications to existing data elements.

8. The system of claim 1, wherein the ontology generator module collaborates with human experts to refine the ontology associated with the ingested datasets.

9. The system of claim 1, wherein the governance module further comprises:
a compliance rule sub-module, adapted to define and enforce rules for data governance based on regulatory and industry standards;
an audit log manager sub-module, adapted to generate and maintain detailed logs of data access, modifications, and governance actions for auditability;
a data masking sub-module, adapted to anonymize sensitive data fields to comply with privacy regulations; and
a policy management sub-module, adapted to create, store, and apply governance policies dynamically based on operational contexts.

10. The system of claim 1, wherein the data analytics module further comprises:
a predictive analytics sub-module, adapted to apply machine learning models to identify trends and forecast outcomes;
a visualization generation sub-module, adapted to create interactive charts, graphs, and dashboards based on analyzed data;
a fraud detection sub-module, adapted to detect anomalies and patterns indicative of fraudulent activities within the first and second datasets.

11. The system of claim 1 further comprises:
a semantic graph database, adapted to store, query, and analyze interconnected data using semantic rules and scalable graph structures.

12. The system of claim 1, wherein the data analysis module is configured to identify fraud and anomaly capabilities using AI and machine learning models.

13. The system of claim 1, wherein the governance module includes automated compliance checks against industry-specific standards, including GDPR, HIPAA, or ISO 27001.

14. The system of claim 1 further comprises a notification module configured to notify users of significant insights, anomalies, or compliance issues.

15. A method for integrated management and governance of a document portfolio, the method comprising:
presenting and/or formulating at least one input query by utilizing a computing unit comprising an application interface;
establishing a communicable connection between a backend server and the application interface of the computing unit by:
receiving document dataset, each comprising a plurality of data elements, from a plurality of data sources in one or more formats;
detecting, normalizing, and aggregating the plurality of data-elements of the document dataset and subsequently storing within a central data repository;
creating and maintaining a dynamic ontology for the ingested datasets in a real-time, wherein the plurality of data elements is categorized and contextualized in accordance with the dynamic ontology;
enforcing & monitoring data compliance policies, the data compliance policies comprising at least a data access-control policy;
analyzing the ingested data and generating actionable insights, wherein the actionable insights include one or more predictive analysis, data accuracy status, governance status, operational inefficiency, risk indicators, compliance gaps, and risk lineage and integrity; and
characterized in that automatically managing, governing & monitoring the received data and subsequently visualizes one or more actionable insights and/or compliance gaps onto the application interface of the computing unit.

16. The method of claim 15, wherein the structured dataset includes tabular data, and logs and metrics, wherein the tabular dataset includes user data, financial data, and inventory data, and logs and metrics include data such as network logs, application usage metrics, and server performance reports.

17. The method of claim 15, wherein the unstructured dataset includes textual data, multimedia data, and sensor data.

18. The method of claim 15, wherein the semi-structured datasets include event data, comments and social media data, web services, and configuration files.

19. The method of claim 15, wherein the meta-tagging utilizes machine learning to dynamically assign and update metadata based on changes in data context or structure.
